(19) United States
(12) Patent Application Publication
(10) Pub. No.: US 2007/0211869 A1
(43) Pub. Date: Sep. 13, 2007

(54) Communications wait music

(75) Inventor: Arto Kiiskinen, San Diego, CA (US)

Correspondence Address: HARRINGTON & SMITH, PC, 4 RESEARCH DRIVE, SHELTON, CT, 06484-6212, US

(73) Assignee: Nokia Corporation

(21) Appl. No.: 10/894,758

(22) Filed: Jul. 19, 2004

(51) Int. Cl. H04M 11/00

(52) U.S. Cl. 379/101.01

(57) ABSTRACT

A system for playing entertainment data during a wait period of a communications call. The system includes a first communications device and a second communications device. The first communications device is adapted to play the entertainment data for a user. The second communications device is adapted to have the communications call with the first communications device. The second communications device is adapted to place the communications call in a wait state. The first communications device includes a system for automatically playing the entertainment data when the communications call is placed in the wait state by the second communications device without transmitting the entertainment data to the first communications device from the second communications device.

### BACKGROUND OF THE INVENTION

1. Field of the Invention

The present invention relates to music or other entertainment data played during a communications call and, more particularly, to a waiting party's selection of music or other entertainment data to be played during call waiting or call hold conditions.

2. Brief Description of Prior Developments

Telephone systems are known in the art which comprise a hold feature, wherein a telephone call can be placed on hold during a call. Telephone systems are also known which comprise call waiting and conference or three-way calling wherein a first telephone call is placed on hold while a user talks to a person on a second telephone call. There are a lot of automated phone systems in the world, such as with large businesses, where a caller has to wait for a long time to get through to a service person. When a user calls into the telephone system, there may be several people in line before him. Incoming calls are placed in a queue. Thus, the user has to wait for the prior callers to be serviced before the user is connected to a service person. Usually, the system plays some kind of waiting music. The system will usually play some default music while the listener is on the line prior to being connected to the service person. The telephone system cannot anticipate what kind of music the user likes, so usually a non-offending music is played. The phone service may also need to pay copyright royalties for the music played.

T-Mobile UK has advertised a service known as Caller Tunes which is a personalized ring back tone service in Europe. Rather than the ubiquitous “ring ring”, a first telephone user calling a second telephone user hears a tune, selected by the second telephone user, which is played for the first telephone user while waiting for the second telephone user to answer his or her telephone.

There is a desire to reduce the amount of money paid as copyright royalties for playing songs during a telephone call waiting state. There is also a desire to allow users, who are placed on hold, to select entertainment data or music to be played during a telephone call waiting state. There is also a desire to provide a higher-quality entertainment data or music during a telephone call waiting state.

### SUMMARY OF THE INVENTION

In accordance with one aspect of the present invention, a system is provided for playing entertainment data during a wait period of a communications call. The system includes a first communications device and a second communications device. The first communications device is adapted to play the entertainment data for a user. The second communications device is adapted to have the communications call with the first communications device. The second communications device is adapted to place the communications call in a wait state. The first communications device includes a system for automatically playing the entertainment data when the communications call is placed in the wait state by the second communications device without transmitting the entertainment data to the first communications device from the second communications device.

In accordance with another aspect of the present invention, a communications device is provided comprising a media player; a call system for placing a call to a receiver; and a system for automatically playing entertainment data by the media player when the receiver places the call from the communications device in a wait state. The communications device is adapted to play the entertainment data without receiving the entertainment data from the receiver during the call.

In accordance with another aspect of the present invention, a communications apparatus is provided comprising a system for receiving telephone calls; a system for placing a first one of the telephone calls in a wait state while communicating with a second one of the telephone calls; and a system for sending a signal to a first telephone, which the first telephone call originated from, to play entertainment data without transmitting the entertainment data by the communications apparatus to the first telephone during the first telephone call.

In accordance with another aspect of the present invention, a system is provided for playing entertainment data during a wait period of a communications call. The system comprising a first communications device; and a second communications device adapted to have the communications call with the first communications device. The second communications device is adapted to place the communications call in a wait state. A system is provided for automatically playing the entertainment data when the communications call is placed in the wait state by the second communications device. The system for playing the entertainment data comprises a system for allowing a user of the first communications device to select the entertainment data to be played while the first communications device is held in the wait state by the second communications device.

In accordance with one method of the present invention, a method for playing entertainment data during a communications call is provided comprising determining by a first communications apparatus when the communications call has been placed in a wait state by a second communications apparatus; and automatically playing the entertainment data by the first communications apparatus when the first communications apparatus has determined that the communications call has been placed in the wait state by the second communications apparatus. The entertainment data is not transmitted to the first communications apparatus from the second communications apparatus during the communications call.

In accordance with another method of the present invention, a method for playing entertainment data during a communications call is provided comprising placing the communications call, between a first communications apparatus and a second communications apparatus, in a wait state by the second communications apparatus; playing the entertainment data by the first communications apparatus while in the wait state; removing the communications call from the wait state by the second communications apparatus; determining by the first communications apparatus when the second communications apparatus has removed the communications call from the wait state; and automatically stopping playing of the entertainment data by the first communications apparatus based upon when the first communications apparatus has determined that the second communications apparatus has removed the communications call from the wait state.

### BRIEF DESCRIPTION OF THE DRAWINGS

The foregoing aspects and other features of the present invention are explained in the following description, taken in connection with the accompanying drawings, wherein:

FIG. 1 is a diagram of a communications system establishing a communications call between two communications devices;

FIG. 2 is a block diagram of some of the components of the first communications device shown in FIG. 1;

FIG. 3 is a block diagram of some of the systems used in the first and second communications devices shown in FIG. 1;

FIG. 4 is a chart showing steps of one embodiment of the present invention;

FIG. 5 is a block diagram of some components of an alternate embodiment of the second communications device; and

FIG. 6 is a diagram showing steps of transmissions between the second communications device shown in FIG. 5 and the first communications device shown in FIG. 1.

### DETAILED DESCRIPTION OF THE PREFERRED EMBODIMENTS

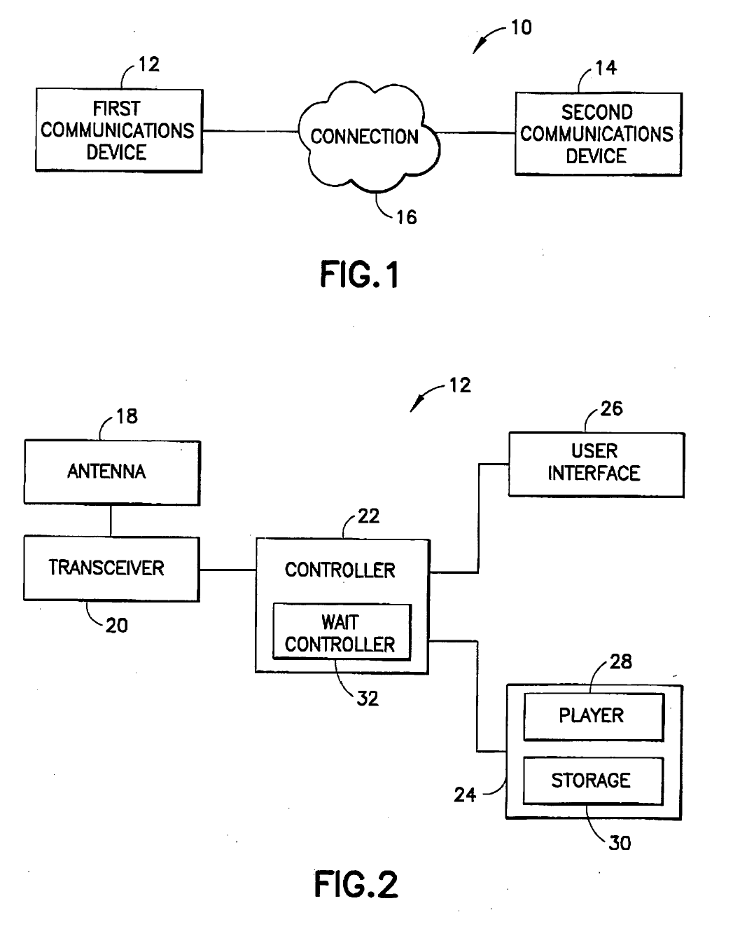

Referring to FIG. 1, there is shown a diagram of a communication system 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

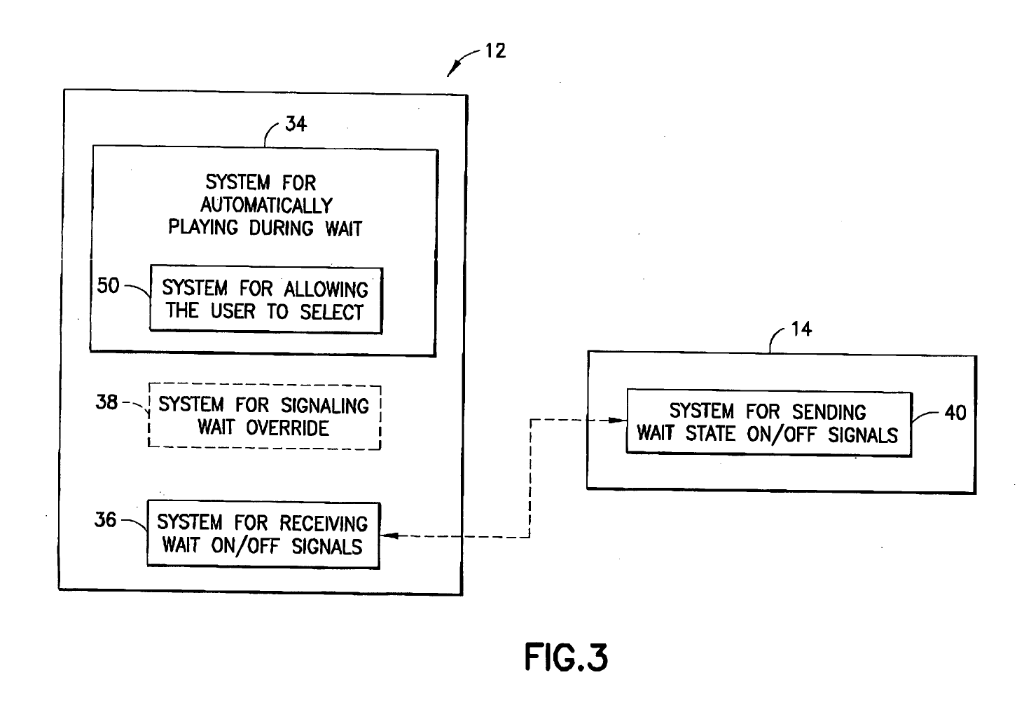

The system 10 generally comprises a first communications device 12 and a second communications device 14 coupled to each other by a connection 16. The first communications device 12 preferably comprises a mobile telephone. The first communications device 12 could comprise any suitable type of electronic telecommunications apparatus such as, for example, a personal data assistant (PDA), a mobile communicator, a laptop or notebook computer, or a mobile game player. In one type of alternate embodiment, the first communications device 12 could comprise a telephone or telephone switch system directly connected to a land line; so long as the telephone comprises an entertainment data player similar to the mobile telephone 12 shown in FIG. 2.

Referring also to FIG. 2, in the embodiment shown the first communications device 12 comprises an antenna 18, a transceiver 20, a controller 22, a player section 24 and a user interface 26. The first communications device 12 obviously comprises other components. For example, for a mobile telephone or mobile communicator the first communications device 12 comprises a display screen, a battery, a microphone and a speaker or sound transducer. The present invention could also be used with mobile devices that are not in just one housing. The mobile devices could be ubiquitous in a sense that storage memory, and perhaps has some other components as well, are outside the housing of the core device. The present invention could be used with a virtual device with all the components existing, but not all in the same “place”.

The user interface 26 can comprise any suitable components, such as a keypad, a touch screen, a trackball, a joystick, etc. The transceiver 20 and antenna 18 are adapted to communicate with the second communications device 14 by means of the connection 16. In the embodiment shown, the connection 16 comprises a wireless link, such as a radio frequency link. The air interface standard may conform to, for example, a Time Division Multiple Access (TDMA) air interface, or a Code Division Multiple Access (CDMA) air interface, or a Frequency Division Multiple Access (FDMA) air interface, or GSM, or 3G. In alternate embodiments, features of the present invention could be used with any suitable type of air interface standard. In an alternate embodiment, features of the present invention could be used with a wired communications system, such as a land line telephone system. The wireless telecommunications system establishes the wireless link to couple the first communications device 12 to a base transceiver station (BTS) of an exemplary network operator of the connection 16.

The network operator generally comprises a mobile switching center (MSC) for connecting to a telecommunications network, such as a public switched telephone network or PSTN, at least one base station controller (BSC), and a plurality of base transceiver stations (BTS) that transmit in a forward or downlink direction both physical and logical channels to the first communications device 12 in accordance with a predetermined air interface standard. A reverse or uplink communication path exists from the first communications device 12 to the network operator, and conveys mobile station originated access requests and traffic, such as voice and possible packet data traffic.

The network operator can include a Message Service Center (MSCT) that receives and forwards messages from the first communications device 12, such as Short Message Service (SMS) messages, or any wireless messaging technique including Email and supplementary data services. In an alternate embodiment, features of the present invention could be used with any suitable type of network operator system.

The first communications device 12 also contains a wireless section that includes a digital signal processor (DSP), or equivalent high-speed processor, as well as the wireless radio frequency (RF) transceiver 20 comprising a transmitter and a receiver. The transceiver is coupled to the antenna 18 for communication with the network operator. In an alternate embodiment, features of the present invention could be used with any suitable type of wireless communications device or mobile phone.

As seen in FIG. 2, the controller 22 is coupled to the transceiver for controlling transmission and reception of signals; or at least processing of those signals. The controller 22 preferably comprises a microprocessor. The controller 22 comprises a wait controller 32 which can comprise a software program. The controller 22 is also coupled to the user interface 26. The controller is also coupled to the player section 24. The player section 24 generally comprises a player 28 and a storage 30. The player 28 preferably comprises a media player. The media player 28 is adapted to play music. However, in alternate embodiments, the media player 28 could also be adapted to play videos or any other suitable type of entertainment data. The player 28 could comprise a device such as an MP3 player. However, any suitable type of media player could be provided. In one type of alternate embodiment, the player 28 could comprise a radio tuned to a local radio station or a satellite radio transmission.

The storage 30 is preferably adapted to store electronic entertainment data, such as in an electronic memory. For example, the storage 30 could comprise a memory which is adapted to store MP3 songs. In an alternate embodiment, the storage 30 could comprise a removable memory module or a removable optical disk. The player 28 is adapted to play the entertainment data stored in the storage 30. Referring also to FIG. 3, the first communications device 12 generally comprises a system 34 for automatically playing entertainment data on the player 28 during a wait state, and a system 36 for receiving wait ON/OFF signals. The first communications device 12 can optionally comprise a system 38 for signaling a wait override request to the second communications device 14.

The second communications device 14 could comprise any suitable type of telecommunication device such as, for example, a mobile telephone, an office telephone switch system, a personal data assistant (PDA), a mobile communicator, a laptop or notebook computer, or a mobile game player. The second communications device 14 comprises a system 40 for sending wait state ON/OFF signals to the receiving system 36 of the first communications device 12. A wait state occurs when the second communications device 14 places the communications call with the first communications device 12 on hold, or in call waiting, or in a call waiting queue. This establishes a wait period during the time which the first communications device keeps the call on hold or in a waiting to be answered queue.

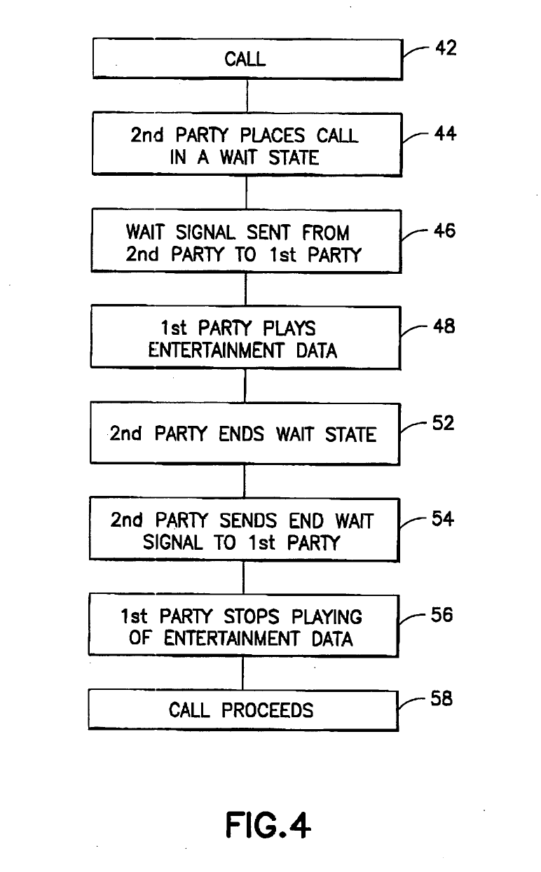

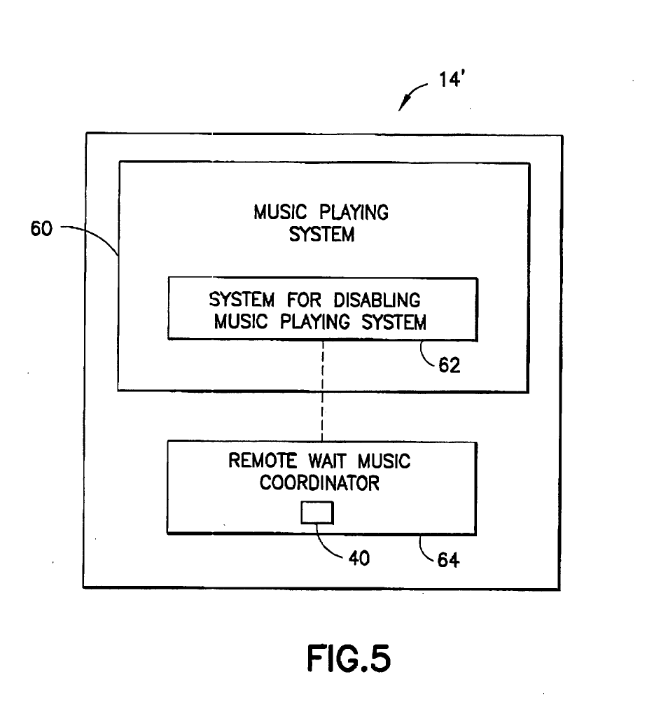

Referring also to FIG. 4, a communications call 42 is established between the first communications device 12 and the second communications device 14, such as when the first device calls the second device or when the second device calls the first device. If the second communications device 14 places the communications call with the first communications device 12 in the wait state as indicated by block 44, the sending system 40 sends a wait signal to the receiving system 36 that the communications call has been placed in the wait state. In other words, that a wait state is ON. When this occurs, the system 34 for automatically playing during wait, located inside the first communications device 12, uses the wait controller 32 to activate the player 28. As indicated by block 48, the first communications device 12, thus, plays entertainment data on the player 28 for the waiting user; i.e., the user of the first communications device 12.

As indicated in FIG. 3, the system for automatically playing 34 can comprise a system 50 for allowing the waiting user to select entertainment data to be played by the player 28. The waiting user can preprogrammed the wait controller 32 to play a specific entertainment data, such as a piece of music, stored in the storage 30. Alternatively, the waiting user can program the wait controller 32 to randomly play one or more of a number of different songs stored in the storage 30. The wait controller 32 could be programmed to play a list of selected songs or an album. In an alternate embodiment, entertainment data stored in the storage 30 could comprise music or songs which are used for generating ring tones when the first communications device 12 is called by another communications device. Although the present invention has principally been described with reference to playing of music during the wait state, features of the present invention could be used to play any suitable type of entertainment data including, for example, a music video. As another alternate embodiment, the player 28 could be adapted to access and play entertainment data remote from the first communications device 12, such as via the Internet.

As seen in FIG. 4, when the second party ends the wait state in the second communications device 14 as indicated by block 52, the second communications device 14 sends an end wait signal to the first communications device 12 as indicated by block 54. The receiving system 36 in the first communications device 12 receives the end wait signal and causes the wait controller 32 to turn OFF the player 28. This causes the first communications device 12 to stop playing the entertainment data as indicated by block 56. The communications call can proceed as indicated by block 58 with the first communications device 12 and the second indications device 14 continuing with the communications call. For example, the user of the first communications device 12 can now talk with a user of the second communications device 14.

Referring now also to FIG. 5, an alternate embodiment of the second communications device 14′ is shown. In this embodiment, the second communications device 14′ comprises a telephone switch system which comprises a music playing system 60 which is adapted to play music for incoming calls when the calls are placed in a wait state, such as in a wait queue or on hold. The music playing system 60 comprises a system 62 for disabling the music playing system; at least for the specific line which the call is on. The second communications device 14′ also comprises a remote wait music coordinator 64. The coordinator 64 is coupled to the disabling system 62. The coordinator 64 is adapted to send and receive signals with the receiving system 36 and signaling system 38 of the first communications device 12 shown in FIG. 3. More specifically, the coordinator 64 is adapted to send wait ON/OFF signals to the receiving system 36. The coordinator 64 is also adapted to receive a wait override signal from the signaling system 38. The coordinator 64 comprises the sending system 40.

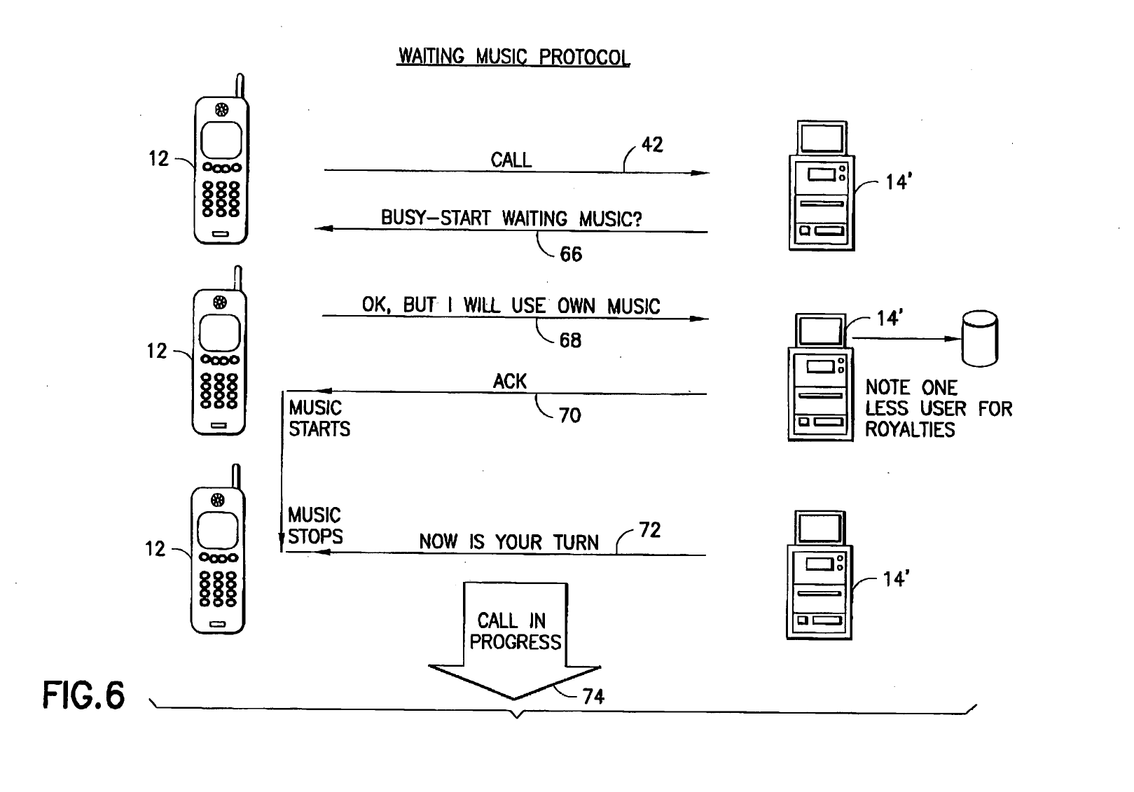

Referring also to FIG. 6, when the first communications device 12 and the second communications device 14′ are in a communications call 42 with each other, if the call is placed in a wait state by the second communications device 14′, such as being placed on hold or in a waiting to answer queue, the sending system 40 sends the wait ON signal 66 to the receiving system 36 of the first communications device 12. When the first communications device 12 receives the wait ON signal, the signaling system 38 of the first communications device 12 can send a wait override request signal 68 from the signaling system 38 of the first communications device to the coordinator 64 of the second communications device 14′. The coordinator 64 can send a signal to the disabling system 62 to disable the music playing system 60 from playing music in the communications call 42. The coordinator 64 can also send an acknowledgement signal 70 back to the first communications device 12. When the first communications device 12 receives the acknowledgment signal 70, the wait controller 32 can allow the player 28 to start playing the entertainment data. When the communications call is subsequently removed from the wait state by the second communications device 14′, the sending system 40 of the coordinator 64 of the second communications system 14 can send a wait state OFF signal 72 to the receiving system 36 of the first communications device 12. The wait controller 32 can stop the player 28 from playing the entertainment data and the call can progress as indicated by arrow 74.

In one type of preferred embodiment, the wait controller 32 is adapted to determine if the communications call has been terminated, such as by a loss of a communications link in a wireless system for example. The wait controller 32 is preferably adapted to stop the player 28 from playing the entertainment data when a termination of the communications call is determined.

In an alternate embodiment signals 68 and 70 might not be provided. Instead, when a call is initiated 42 a signal can be attached indicating that the calling party has the ability to play its own entertainment data. Any subsequent need by the called party to place the calling party in a wait state would then simply result in the signal 66 being sent back to the calling party, indicating “busy; start waiting music”. The device of the calling party could then start playing its own music.

With the present invention, a protocol can be defined for the waiting music to be the music residing in a telephone rather than music transferred in a call. In the future, most portable or mobile telephones will have digital music stored in them. The present invention allows use of this stored music as waiting music rather than music transferred over poor quality voice codec over a telephone line. The present invention can provide a protocol to negotiate the usage of waiting music in a calling terminal. Thus, with the present invention a user can get better quality music as waiting music, and the waiting music can be of a type which the user likes.

As noted above, telephone services can pay copyright royalties for music played during telephone waiting or holding periods. In the past, royalty payments have been reduced by playing music that is not controlled by copyrights such as Muzak or ding done tones type of music. This is not very courteous to the call user. The present invention could provide a less expensive system for telephone service in companies because they would not need to pay as much in copyright royalties. They also do not need to play music to some many people. In fact, with the present invention, the telephone service in a company could do away with having to play hold or call waiting music altogether. The call user would much prefer to listen to music that he or she enjoys. With the present invention, the call waiting music can be selected or personalized by the person being placed on hold or when in a call waiting queue.

With the present invention, such as when implemented in a mobile telephone, the mobile telephone could play music contained in the handset itself when the user is in a queue of call waiting or on hold. Playing of saved music on the handset could be initiated by a command from the company and the music played on the handset could either be the users ring tones or a selection of tunes, such as from an MP3 player in the mobile telephone. The playing of a musical file contained in the telephone can be manually activated by the recipient user when the caller is subjected to a call waiting by the recipient user, and automatically ended when taken out of the queue.

The present invention provides an advantage in that the user being placed on hold or call waiting can listen to music that he or she likes. This wait music can be a selected or customized by the user placed on hold or call waiting. The user being placed on hold or call waiting has already purchased rights to the music. Therefore, no additional copyright royalties need to be paid. The present invention also provides an advantage in that the telephone service does not need to pay royalties for those users who already own their own music which is used for call waiting or on hold music. The present invention could be expanded to include more than just one song. For example, the user could create whole playlists or define albums to be played. The initiator of a call, which is subsequently placed on hold or call waiting, can be responsible for choosing the entertainment data or music file to be heard while being held on hold; for example with call waiting.

For a user who is placed on hold and is simply listening to music which originates from his or her own handset instead of the other party, it is possible for the caller to enter a “half rate mode” in order to save on costs while waiting for the other party to answer. Thus, the person placed on hold or waiting does not need to pay, such as with a wireless call, to keep the call in force when nothing is being transmitted or received between the two parties. At present, in order for music quality to be kept at an acceptable level, to put the handset in a half rate mode would deteriorate music quality. With the present invention, music quality would not deteriorate when the signal transmission rate is reduced to a lower lever during a wait state.

The present invention can preferably be used with a wireless mobile telephone. However, features of the present invention are not limited only to mobile handsets. The present invention can be used with any voice communications recipient where the initiator has in his or her own database of music files (e.g., PDA, mobile handset, etc.). The present invention can be implemented with a session initiation protocol (SIP) either using caller preferences wherein the contact header. The caller may indicate certain preferences such as audio, video calls, etc. Therefore, it could use this header or others to indicate the preferred music.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for playing entertainment data during a wait period of a communications call, the system comprising:
a first communications device, wherein the first communications device is adapted to play the entertainment data for a user; and
a second communications device adapted to have the communications call with the first communications device, wherein the second communications device is adapted to place the communications call in a wait state,
wherein the first communications device comprises a system for automatically playing the entertainment data when the communications call is placed in the wait state by the second communications device.

2. A system for playing entertainment data during a wait period of a communications call as in claim 1 wherein the first communications device comprises a mobile telephone.

3. A system for playing entertainment data during a wait period of a communications call as in claim 1 wherein the first communications device comprises a media player which is adapted to play the entertainment data.

4. A system for playing entertainment data during a wait period of a communications call as in claim 1 wherein the entertainment data comprises music, and the first communications device is adapted to play the music.

5. A system for playing entertainment data during a wait period of a communications call as in claim 1 wherein the first communications device comprises a music storage system, and wherein the system for automatically playing the entertainment data is adapted to play music stored in the music storage system when the communications call is placed in the wait state by the second communications device.

6. A system for playing entertainment data during a wait period of a communications call as in claim 1 wherein the system for automatically playing the entertainment data comprises a system for allowing the user of the first communications device to select the entertainment data to be played.

7. A system for playing entertainment data during a wait period of a communications call as in claim 1 wherein the second communications device comprises a music playing system adapted to play music for the first communications device when the second communications device places the communications call with the first communications device in the wait state.

8. A system for playing entertainment data during a wait period of a communications call as in claim 7 wherein the music playing system of the second communications device comprises a system for disabling playing of the music by the music playing system in the communications call when the first communications device plays the entertainment data.

9. A system for playing entertainment data during a wait period of a communications call as in claim 1 wherein the system for automatically playing the entertainment data comprises a system for signaling the second communications device that the first communications device will play the entertainment data.

10. A system for playing entertainment data during a wait period of a communications call as in claim 1 wherein the system for automatically playing the entertainment data comprises a system for receiving signals from the second communications device for turning the playing of the entertainment data ON and/or OFF.

11. A communications device comprising:
a media player;
a call system for placing a call to a receiver; and
a system for automatically playing entertainment data by the media player when the receiver places the call from the communications device in a wait state, wherein the communications device is adapted to play the entertainment data without receiving the entertainment data from the receiver during the call.

12. A communications device as in claim 11 wherein the media player comprises an MP3 player.

13. A communications device as in claim 11 wherein the communications device comprises a mobile telephone.

14. A communications device as in claim 11 wherein the entertainment data comprises music.

15. A communications device as in claim 11 wherein the communications device comprises a music storage system, and wherein the system for automatically playing the entertainment data is adapted to play music stored in the music storage system when the call is placed in the wait state by the receiver.

16. A communications device as in claim 11 wherein the system for automatically playing the entertainment data comprises a system for allowing the user of the communications device to select the entertainment data to be played.

17. A communications device as in claim 11 wherein the system for automatically playing the entertainment data comprises a system for sending a signal that the communications device will play the entertainment data during the wait state.

18. A communications device as in claim 11 wherein the system for automatically playing the entertainment data comprises a system for receiving signals from the receiver for turning the playing of the entertainment data ON and/or OFF.

19. A communications apparatus comprising:
a system for receiving telephone calls;
a system for placing a first one of the telephone calls in a wait state while communicating with a second one of the telephone calls; and
a system for sending a signal to a first telephone, which the first telephone call originated from, to play entertainment data without transmitting the entertainment data by the communications apparatus to the first telephone during the first telephone call.

20. A communications apparatus as in claim 19 wherein the communications apparatus comprises a mobile telephone.

21. A communications apparatus as in claim 19 wherein the entertainment data comprises music.

22. A communications apparatus as in claim 19 wherein the system for sending a signal comprises a system for sending signals from the first telephone for turning the playing of the entertainment data by the first telephone ON and/or OFF.

23. A communications apparatus as in claim 19 further comprising a music playing system adapted to play music for the first telephone when the communications apparatus places the first telephone call in the wait state.

24. A communications apparatus as in claim 23 wherein the music playing system is adapted to stop playing of music by the music playing system when the first telephone plays the entertainment data during the wait state.

25. A communications apparatus as in claim 19 wherein the communications apparatus does not comprise a mobile telephone.

26. A communications apparatus as in claim 19 wherein the communications apparatus is configured to receive telephone calls at least partially by a wired connection.

27. A system for playing entertainment data during a wait period of a communications call, the system comprising:
a first communications device; and
a second communications device adapted to have the communications call with the first communications device, wherein the second communications device is adapted to place the communications call in a wait state; and
a system for automatically playing the entertainment data when the communications call is placed in the wait state by the second communications device, wherein the system for playing the entertainment data comprises a system for allowing a user of the first communications device to select the entertainment data to be played while the first communications device is held in the wait state by the second communications device.

28. A method for playing entertainment data during a communications call comprising:
determining by a first communications apparatus when the communications call has been placed in a wait state by a second communications apparatus; and
automatically playing the entertainment data by the first communications apparatus when the first communications apparatus has determined that the communications call has been placed in the wait state by the second communications apparatus,
wherein the entertainment data is not transmitted to the first communications apparatus from the second communications apparatus during the communications call.

29. A method as in claim 28 further comprising selecting by a user of the first communications apparatus the entertainment data to be played by the first communications apparatus during the wait state.

30. A method as in claim 28 further comprising sending a signal from the first communications apparatus to the second apparatus indicating that the first communications apparatus will play the entertainment data.

31. A method as in claim 28 further comprising sending a signal from the second communications apparatus to the first communications apparatus turning the playing of the entertainment data by the first communications apparatus ON and/or OFF.

32. A method for playing entertainment data during a communications call comprising:
placing the communications call, between a first communications apparatus and a second communications apparatus, in a wait state by the second communications apparatus;
playing the entertainment data by the first communications apparatus while in the wait state;
removing the communications call from the wait state by the second communications apparatus;
determining by the first communications apparatus when the second communications apparatus has removed the communications call from the wait state; and
automatically stopping playing of the entertainment data by the first communications apparatus based upon when the first communications apparatus has determined that the second communications apparatus has removed the communications call from the wait state.

33. A communications apparatus comprising:
a system for receiving telephone calls;
a system for placing a first one of the telephone calls in a wait state while communicating with a second one of the telephone calls; and
a system for playing entertainment data in the first telephone call while the first telephone call is in the wait state,
wherein the communications apparatus is adapted to receive a signal in the first telephone call and, based upon reception of the signal, is adapted to disable playing of the entertainment data in the first telephone call during the wait state.

34. A method for playing entertainment data during a communications call comprising:
determining by a first communications apparatus when the communications call has been placed in a wait state by a second communications apparatus; and
automatically changing a signal transmission rate with the first communications apparatus from a first higher rate to a second lower rate when the communications call has been placed in the wait state by the second communications apparatus.

35. A method as in claim 34 further comprising automatically changing the signal transmission rate from the second lower rate to the first higher rate when the communications call is removed from the wait state.
